(19) United States
(12) Patent Application Publication
(10) Pub. No.: US 2017/0290324 A1
(43) Pub. Date: Oct. 12, 2017

(54) Spike Attachment for Steam Weed Killing Apparatus

(71) Applicant: Dynamic Solutions Worldwide, LLC, Milwaukee, WI (US)

(72) Inventors: Juan Rocha, Lake Forest, IL (US); Robert Seaton, Verona, WI (US)

(21) Appl. No.: 15/091,664

(22) Filed: Apr. 6, 2016

(51) Int. Cl. A01M 21/04

(52) U.S. Cl. CPC A01M 21/04

(57) ABSTRACT

A steam weed killing apparatus with a multi-spiked attachment for delivering steam beneath the ground is provided. The multi-spiked attachment provides an arrangement of spikes to encircle the weed for heat treatment of the weed's roots. Each spike comprises an elongated hollow tube terminating at a removable tip for penetrating the ground. The elongated hollow tube has ventilation holes allowing the steam to escape. When the steam generator is operated, pressured steam is delivered to the attachment. Steam travels down the elongated hollow tube of the spike and exits at the ventilation holes to heat the roots. The tip of the spike may be removed to assist in the removal of dirt clogs within the elongated tube.

### CROSS-REFERENCES TO RELATED APPLICATIONS

-

### BACKGROUND OF THE INVENTION

This invention relates to the field of weed killing and/or weed killing apparatuses. More specifically, this invention relates to a water vapor or steam generator for killing weeds using steam treatment and/or an attachment connectable to the steam generator for steam delivery, usually directly to the root part of weeds underground. The steam generator attachment was developed to facilitate removal of clogged passageways in the attachment and improve steam delivery to the weeds.

There are many known methods for destroying weeds. Many involve the use of chemical herbicides, pesticides, and fungicides. However, strong chemical herbicides, pesticides, and fungicides can pollute the drinking water, groundwater, and surface water. They can also be dangerous to children or pets that might accidently ingest the chemicals. Therefore, there is a need and desire for environmentally friendly methods for destroying weeds.

One method for killing weeds without the use of harsh chemicals is by using heat. Direct heat to weeds, for example, pouring boiling water over the weeds or applying a flame to the weed above the ground, will cause the weed to wilt. Typically, repeated applications of heat are required to fully kill the weed, gradually killing any leaves that may re-sprout from the roots.

Applying heat to the root above the ground can result in heat loss as the ground absorbs a lot of heat instead of the weed itself. Therefore, it is found that applying heat directly to the root of the weed reduces heat loss and kills the weed at its source, minimizing the chances of re-sprouting.

The present invention seeks to provide an improved way to kill weeds using a steam generator with an attachment which directs steam into the ground in a more energy efficient and environmentally safe manner.

### SUMMARY OF THE INVENTION

The present invention provides a steam weed killing apparatus with a multi-spiked attachment for delivering steam underground. The multi-spiked attachment provides an arrangement of spikes to encircle the weed for heat treatment of the weed's roots. Each spike comprises an elongated hollow tube terminating at a removable tip for penetrating the ground. The elongated hollow tube has ventilation holes allowing the steam to escape. When the steam generator is operated, pressured steam is delivered to the attachment. Steam travels down the elongated hollow tube of the spike and exits at the ventilation holes to heat and dry out the roots. The tip of the spike may be removed to assist in the removal of dirt clogs within the elongated tube.

One embodiment of the present invention provides a steam weed killing apparatus having a steam generator including a water chamber and an electric steam generating means; a conduit providing a passageway for steam to pass from the steam generator to an outlet; and an attachment connectable to the conduit outlet and including a manifold receiving steam from the outlet, at least one spike attached to the manifold having an elongated hollow tube terminating at a removable tip body wherein the elongated hollow tube has at least one hole along a length of the elongated hollow tube.

It is thus a feature of at least one embodiment of the invention to provide a steam weed killer attachment providing a removable tip to allow dirt within the ventilation hole to be easily unclogged.

The present invention provides that the elongated hollow tube has two holes along the length of the elongated hollow tube.

It is thus a feature of at least one embodiment of the invention to deliver steam directly to the weed's roots underground and to contact more of the root.

The present invention provides that the two holes are spaced apart along a length of the elongated hollow tube.

It is thus a feature of at least one embodiment of the invention to deliver steam to different depths of the weed's root. The length of the spike approximates the length of the roots, allowing the steam to reach a full depth of the root.

The present invention provides that the attachment has three spikes attached to the manifold.

It is thus a feature of at least one embodiment of the invention to allow the spikes to encircle the weed for 360 degree coverage of the weed's roots.

The present invention provides that the attachment has at least two spikes.

It is thus a feature of at least one embodiment of the invention to allow for different arrangements of the spikes to encircle different shapes and sizes of weeds.

The present invention provides that at least one hole is oriented toward a mid-point between all the spikes.

It is thus a feature of at least one embodiment of the invention to direct the steam toward a center of the weed or directly at the weed's roots.

The present invention provides that a rear end of the tip body has a threaded attachment to receive a second threaded attachment of the elongated hollow tube.

It is thus a feature of at least one embodiment of the invention to permit the tip body to be detached from the elongated hollow tube to allow de-clogging of the spike's holes or the elongated hollow tube itself.

The present invention provides that tip body is stainless steel.

It is thus a feature of at least one embodiment of the invention to prevent rusting of the spike and provide a material that can repeatedly pierce the ground soil without breakage.

The present invention provides the tip body has a depression to facilitate rotation of the tip body with respect to the elongated hollow tube.

It is thus a feature of at least one embodiment of the invention to assist the user in gripping the tip and screwing/unscrewing the tip body to/from the elongated hollow tube. The depression is deep enough to provide a grip to the user without largely retaining debris or soil.

One embodiment of the present invention provides a steam weed killing apparatus attachment including an attachment connectable at a first end to a steam source and including a manifold being at least partially hollow and connectable to the steam source at a first end, and at least one spike extending outward from a second end of the manifold and defined by an elongated hollow tube terminating at a removable tip wherein the elongated hollow tube has at least one hole disposed along a length of the elongated hollow tube.

It is thus a feature of at least one embodiment of the invention to provide a replaceable attachment which can be used in combination with a standard steam generating appliance.

The present invention provides that the spikes are fixedly retained to the manifold.

It is thus a feature of at least one embodiment of the invention to allow the spikes to pierce the ground without movement of the spikes.

The present invention provides that there are three spikes arranged in a triangular formation.

It is thus a feature of at least one embodiment of the invention to arrange the spikes in a formation in which they encircle the weed's roots underground. Also, providing only the necessary number of spikes necessary for effective delivery of steam to the weed.

The present invention provides that the spikes protrude from the manifold at different lengths.

It is thus a feature of at least one embodiment of the invention that the spikes deliver steam to the weed's roots at different depths within the ground.

The present invention provides that the spikes protrude from the manifold at substantially similar lengths.

It is thus a feature of at least one embodiment of the invention that the spikes are of equal length to make it easier for the attachment to penetrate the ground.

The present invention provides that the tip forms a blunted end.

It is thus a feature of at least one embodiment of the invention to make it easier for the spikes to penetrate the ground.

One embodiment of the present invention provides a method of killing weeds having the steps of providing a steam weed killing apparatus having a steam generator, an attachment connectable to the steam generator and including a manifold receiving steam from the steam generator, at least one spike attached to the manifold having an elongated hollow tube terminating at a removable tip body wherein the elongated hollow tube has at least one hole along a length of the elongated hollow tube; connecting the attachment to the steam generator; delivering steam through the attachment; and rotating the tip body to remove the tip body from the elongated tube.

One embodiment of the present invention provides that the spikes are inserted into the ground to encircle a center of the weed.

One embodiment of the present invention provides the step of rotating the tip body to replace the tip body onto the elongated tube.

These particular objects and advantages may apply to only some embodiments falling within the claims and thus do not define the scope of the invention.

### BRIEF DESCRIPTION OF THE VIEWS OF THE DRAWINGS

FIG. 1 is a perspective view of a user operating a steam weed killing apparatus with a spike attachment according to the present invention;

FIG. 2 is an isometric view of the spike attachment of the present invention with three spikes extending therefrom;

FIG. 3 is an exploded, side elevational view of a spike as would be received by a manifold of the spike attachment of FIG. 2 with a removable tip removed;

FIG. 4 is an enlarged perspective view of the user installing the spike attachment to the steam weed killing apparatus; and

FIGS. 5 and 6 are enlarged perspective views of the user preparing to insert and then inserting the spikes of the spike attachment into the ground surrounding the weed's roots to kill the weed.

### DETAILED DESCRIPTION OF THE INVENTION

A wide variety of spike attachments could be constructed in accordance with the invention as defined by the claims. Any one of these assemblies could be used in conjunction with any number of steam generators. Hence, while the preferred embodiments of the invention will now be described with reference to the steam generator as shown, it is understood that the invention is in no way so limited.

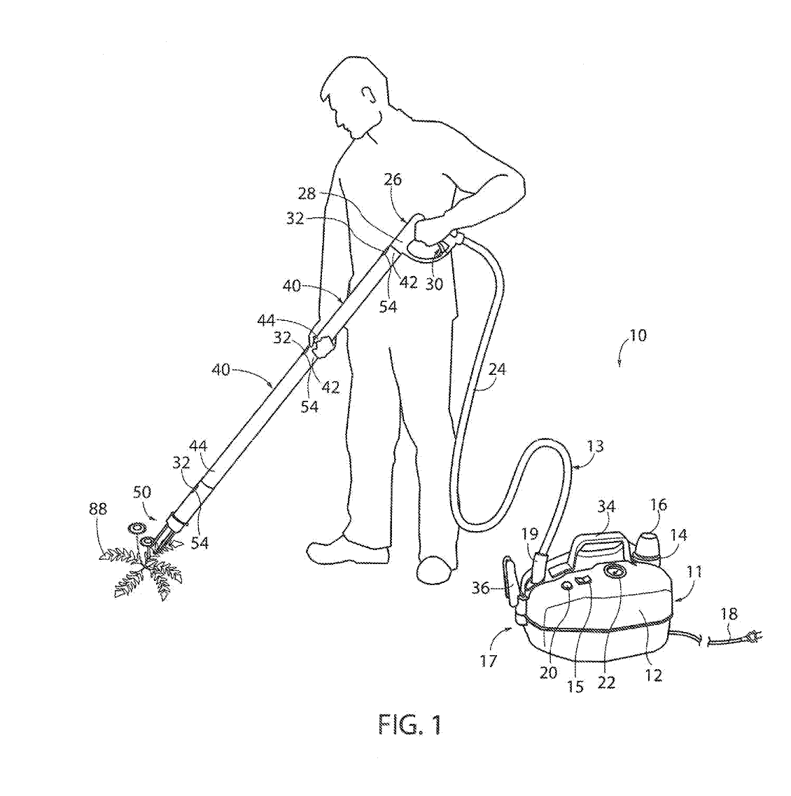

Referring to FIG. 1, a perspective view of a user operating a steam apparatus 10 with a spike attachment 50 according to the present invention is shown. The steam apparatus 10 according to one embodiment of the present invention may provide a housing 11, a conduit 13 for delivering steam to a steam gun 26, and the steam gun 26 selectively connected to an attachment, such as the spike attachment 50. The housing 11 provides a cavity for receiving a water chamber 12 for retaining water and an electric steam generating means 17 for converting the water to steam. The spike attachment 50 may be in communication with the water chamber 12 to deliver steam directly to a weed 88 that is external to the steam apparatus 10.

Still referring to FIG. 1, the housing 11 may carry the water chamber 12 defined by a sealable enclosure holding water or another fluid that is to be converted into steam. The water chamber 12 may be filled with water through an inlet 14 which is covered and sealed by a fill cap 16. The fill cap 16 may be twist fastened over the inlet 14 to seal the water chamber 12. The water chamber 12 when sealed by the fill cap 16 provides a substantially closed system. The water chamber 12 may hold up to and about 2000 ml of water in order to provide extended operation of the apparatus 10, for example, for up to one hour of steam delivery.

The housing 11 may provide a handle 34 for ease of carrying. The housing 11 may also provide a tube supporter 36 for supporting the conduit 13 and/or attachments against the housing 11 in an upright position when not in use.

Steam is produced within the housing 11 by a steam generating means 17. The steam generating means 17 heats the water to produce steam, while also increasing the pressure within the water chamber 12. The steam apparatus 10 is connected to a power source via a power cord 18. For example, the power cord 18 may be connected to a wall outlet (not shown). An ON/OFF switch 15 operates the electric steam generating means 17. When the steam apparatus 10 is turned ON, the electric steam generating means 17 works to heat the water within the water chamber 12. The steam generating means 17 may be a heating element, such as heating plates that quickly heat the water. By heating the water in the substantially closed container, the pressure in the chamber 12 also increases.

As the pressure within the water chamber 12 builds, the housing 11 may provide a visual indication, such as a colored light 20 or a manometer 22, to give the user an indication of the internal pressure within the device. A certain pressure is required to properly operate the device to release steam. For example, a colored light 20 may illuminate to indicate that pressure is building within the water chamber 12 and/or there is not enough pressure to release steam. Then, the colored light 20 may un-illuminate to indicate that there is sufficient pressure within water chamber 12 to release steam. Alternatively, or in addition, the manometer 22 may provide a real-time visual indication of the internal pressure within the water chamber 12. The manometer 22 may be a digital display or an analog dial displaying the pressure level within the water chamber 12. For example, the desired pressure for operation may be between 2.5 and 4.5 bar, and approximately 4.2 bar. If the pressure falls below about 2.5 bar, then it may be advisable to allow the pressure to build up again before operating the device.

A controller board within the housing 11 may receive input data for control of the weed killing apparatus 10 stored in a memory. The controller board generally provides an electronic computer executing a program stored in computer memory to control the steam ON/OFF switch 15, the electric steam generating means 17, colored lights 20 and/or manometer 22. For example, the program may hold a schedule for a predetermined threshold pressure. The schedule may include a threshold pressure in which the device may be operated to dispel steam. When the ON/OFF switch 15 is turned ON, the controller board may communicate with the manometer 22 to receive a signal of the internal pressure. The internal pressure is compared to the threshold pressure and if the internal pressure is less than the threshold pressure, the controller board will communicate with the colored lights 20 to illuminate the lights. And if the internal pressure is equal to or greater than the threshold pressure, the controller board will communicate with the colored lights 20 to un-illuminate the lights. Other schedules may be stored, such as threshold temperatures in which the controller board may communicate with a temperature sensor and shut down the apparatus 10 if the apparatus is over the threshold temperature indicating overheating. The controller board may also communicate with a water level sensor and turn on a warning light if the water chamber 12 is low or empty and needs to be refilled with water.

Steam is delivered from the water chamber 12 to the weed 88 through conduit 13. The conduit 13 may provide a hose 24 connectable to an outlet 19 of the water chamber 12. The outlet 19 allows the steam to exit the housing 11. The hose 24 may be flexible tubing allowing the steam to pass from the outlet 19 along the length of the hose 24. The end of the hose 24 may provide a steam gun 26 having a nozzle 28 for selective attachment of an attachment device and a trigger 30 or switch for controlling the passage of steam through the nozzle 28. The trigger 30 may be a valve controlling the flow of steam through the nozzle 28. Once there is sufficient pressure built up, the user may press the trigger 30 of the steam apparatus 10 to deliver steam out the nozzle 28. A generally closed system is found between the water chamber 12, conduit 13, and steam gun 26. Opening the nozzle 28 will open the closed system to release the pressurized steam.

The nozzle 28 may be smaller in diameter than a receiving end of an attachment part, as will be further described below. The nozzle 28 may include a button 32 for receiving and securing an attachment part, as will be further described below.

The steam apparatus 10 as described may generally conform to the steam product sold by Dynamic Solutions Worldwide, LLC under the name Dynasteam®. It is understood that various attachment parts may be attached to the nozzle 28 of steam gun 26 for different purposes of steam delivery. However, two such attachments, spike attachment 50 and extension tube attachment 40, will be described in further detail below.

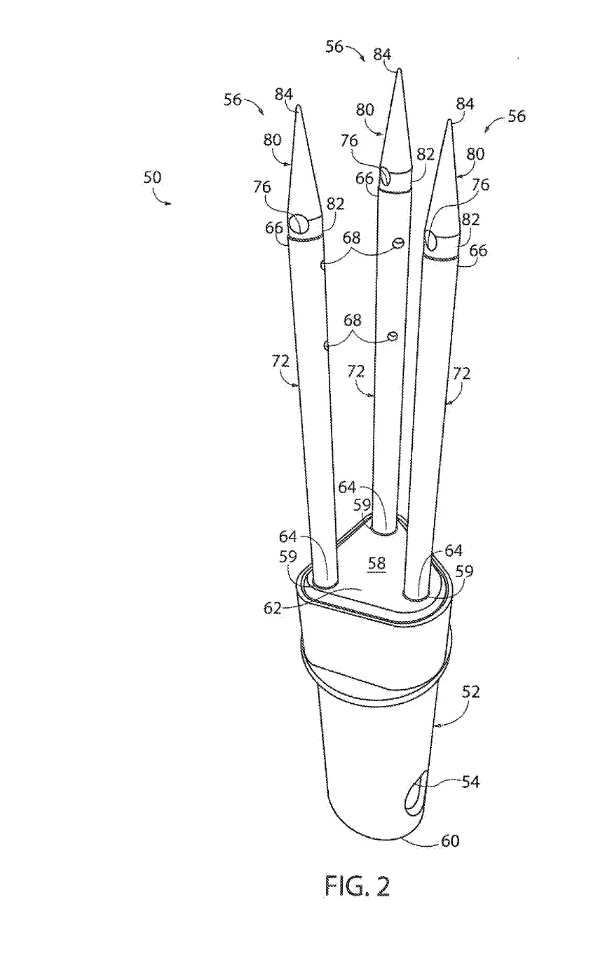

An isometric view of the spike attachment 50 that would be installed on the steam apparatus 10 is shown in FIG. 2. The spike attachment 50 may be installed onto the nozzle 28 directly, or via an extension tube attachment 40 installed between the nozzle 28 and the spike attachment 50 as seen in FIG. 1. FIG. 1 shows two extension tube attachments 40 connected in parallel between the nozzle 28 and the spike attachment 50. In an alternative embodiment, one extension tube attachment 40 is connected in parallel between the nozzle 28 and the spike attachment 50. In an alternative embodiment, the spike attachment 50 is attached directly to the nozzle 28 of the steam gun 26.

The extension tube attachment 40 may be an elongated tube allowing steam flow therethrough the tube. More than one extension tube attachment 40 may be connected in parallel to increase the distance between the nozzle 28 and the spike attachment 50. For example, multiple extension tube attachments 40 may be connected in parallel to a length that is approximately half of an average human's height. A first end 42 of the extension tube attachment 40 may be attached to the nozzle 28, and a second end 44 of the extension tube attachment 40 may be attached to the spike attachment 50 or another extension tube attachment 40.

Referring now to FIG. 2, an isometric view of the spike attachment 50 of the present invention is shown. The spike attachment 50 according to one embodiment of the invention includes a manifold 52 attachable to the extension tube attachment 40 (or nozzle 28), and includes at least one spike 56 extending therefrom the manifold 52.

The manifold 52 of the spike attachment 50 is defined by a hollow tubular body with an open end 60 opposite end 62. The open end 60 has a slightly larger diameter than the extension tube attachment 40 (or nozzle 28) to be connectable therewith, as will be further described below. The manifold 52 also may provides a hole 54 proximate to but inward of the open end 60 for receiving the button 32 of the extension tube attachment 40, as will be further described below. The open end 60 is adapted to receive steam from the nozzle 28 into the hollowed body of the manifold 52. The end 62 of the manifold 52 branches into several openings 59 where the multiple spikes 56 are received. The end 62 of the manifold 52 may be partially enclosed by a support surface 58 for retaining the spikes 56 therein. The support surface 58 provides openings 59 which are substantially equal in diameter to the diameter of the elongated tubes 72. The elongated tubes 72 of the spikes 56 are received within and supported by the openings 59.

The spikes 56 may be defined by elongated tubes 72 attached to removable tips 80. The elongated tubes 72 are substantially hollow with opposing open ends providing a conduit for steam to pass through. A first end 64 of the elongated tubes 72 are inserted into the support surface 58 and an opposite second end 66 are attached to the removable tip 80. The first end 64 communicates with the manifold 52 to allow steam to pass from the manifold 52 through the hollow tubes 72.

As seen in the embodiment shown in FIG. 2, the support surface 58 may carry three spikes 56 protruding outward in a parallel fashion. The spikes 56 may be between approximately 2.75 inches and 4.25 inches in length. The length of the spikes 56 may approximate a length of extension of the weed's roots 92 below ground. The spikes 56 may be the same length or be different lengths with respect to each other. The spikes 56 may be constructed of a metal, such as stainless steel.

The three spikes 56 may be arranged in an equally spaced apart formation, and with three spikes the formation may be arranged in a triangular formation. It is understood that with four spikes, the spikes may take a rectangular formation, and with more than four spikes, the spikes may take a circular formation.

The spikes 56 may be fixedly attached to the support surface 58 to prevent movement of the spikes 56. In this respect, the spikes 56 are unable to slide with respect to the support surface 58. The spikes 56 may be retained within the openings 59 of the support surface 58 by an adhesive attachment around a circumference of the spike 56, however, it is understood that other attachment means may be used to attach the spikes 56 to the manifold 52. For example, the spikes 56 may also be friction fitted within the openings 59.

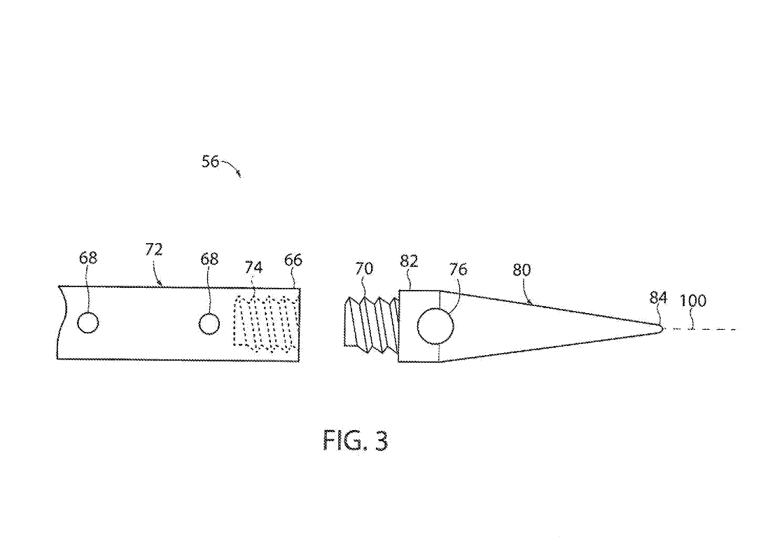

Referring also to FIG. 3, a plurality of ventilation holes 68 may be disposed along a length of the elongated tubes 72 allowing steam to escape. The ventilation holes 68 allow passage from an interior to an exterior of the elongated tubes 72. The ventilation holes 68 are generally close to the removable tip 80, when the tip is attached, and further from the support surface 58 to allow deeper delivery of steam, but may be arranged at any position along the length of the elongated tubes 72. Any number of ventilation holes 68 may be present, and at any location along the elongated tubes 72. As shown, the elongated tubes 72 include two ventilation holes 68 per spike 56 spaced apart along the elongated tubes 72. A first hole is positioned approximately 2.5 inches from the end of the removable tip 80, and a second hole is positioned 3.25 inches from the end of the removable tip 80.

As seen in FIG. 2, the ventilation holes 68 may be generally oriented such that the holes 68 face inward toward a center of the spike 56 arrangement. For example, the holes 68 may face toward a center of the triangle, rectangle or circular formation formed by the spikes 56. In this respect, the steam exiting the ventilation holes 68 is directed toward a center of the spike 56 arrangement where the weed 88 is centrally located.

The second end 66 of the hollow tube 72 is enclosed by the removable tip 80. Removable tip 80 provides a cylindrical body 82 tapering to a point 84. The cylindrical body 82 extends along an axis 100 to the removable tip 80 formed by a face converging to the point 84. The point 84 may be pointed or blunted for ease of penetration into the soil. The removable tip 80 holds a threaded boss 70 opposite the point 84 and is substantially equal in diameter to the hollow tube 72 as it attaches to a threaded socket 74 of the elongated tube 72. It is understood that many coupling mechanisms are available to attach the removable tip 80 to the elongated tube 72.

The removable tip 80 may include a depression 76 assisting in the rotation of the removable tip 80 with respect to the hollow tube 72. The depression 76 may be relatively shallow to allow the user to grip the removable tip 80 without retaining dirt therein. The depression 76 may also be replaced with a protrusion also allowing the user to more easily grip the tip 80 for twisting and/or removal.

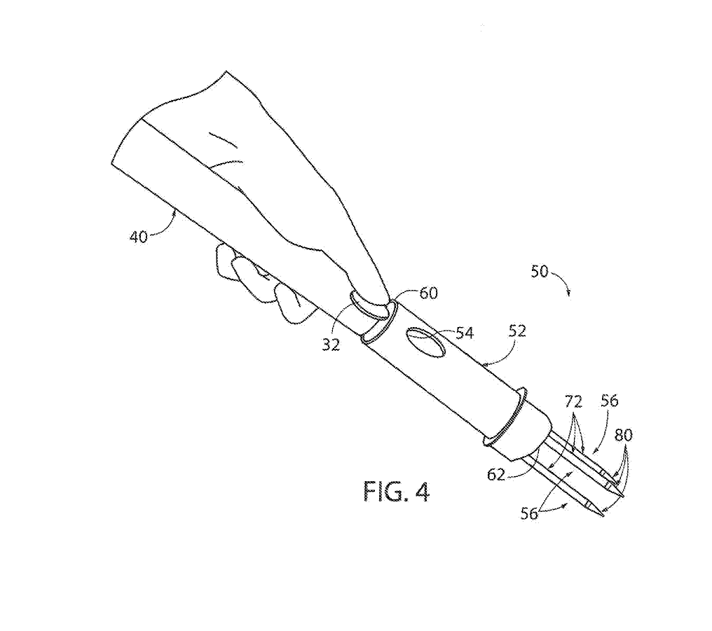

We proceed to describe assembly and operation of the steam apparatus 10. Referring to FIG. 4, the user attaches the spike attachment 50 to the nozzle 28 of the steam gun 26 or the extension tube attachment 40. As shown, the spike attachment 50 is attached to a receiving end of the extension tube attachment 40. The spike attachment 50 is installed by fitting the open end 60 of the manifold 52 over the receiving end of the extension tube attachment 40.

Referring to FIG. 4, the button 32 of the extension tube attachment 40 may be biased toward an extended or outward state. To allow the connectable ends to join, the button 32 may be depressed inward to allow the open end 60 of the spike attachment 50 to slide over the attachment end of the extension tube attachment 40. Once the mating ends are fitted together, the button 32 may align within the hole 54 so that the button 32 may extend outward through the hole 54. Thus, the button 32 and hole 54 are fixed with respect to one another to secure the extension tube attachment 40 to the manifold 52. It is understood that the attachment ends of the nozzle 28, extension tube attachment 40, and/or spike attachment 50 may be coupled in a similar manner. The connection ends of the extension tube attachment 40 and the manifold 52 are also friction fitted so as to provide a continuous substantially sealed passageway between the nozzle 28 and/or attachments.

The user unscrews the fill cap 16 and fills the chamber 12 to a desired water level with water or another fluid. Once filled to a desired level, the fill cap 16 is screwed back on to seal the chamber 12.

The steam apparatus 10 is connected to a power source via the power cable 18 and the ON/OFF switch 15 is turned ON to operate the electric steam generating means 17. Steam will proceed to build within the water chamber 12 until there is an indication that the pressure is high enough to operate the device and eject steam. This may be indicated to the user by the colored light 20 or manometer 22. When there is an indication that the pressure is sufficient, the ON/OFF switch 15 may be turned OFF.

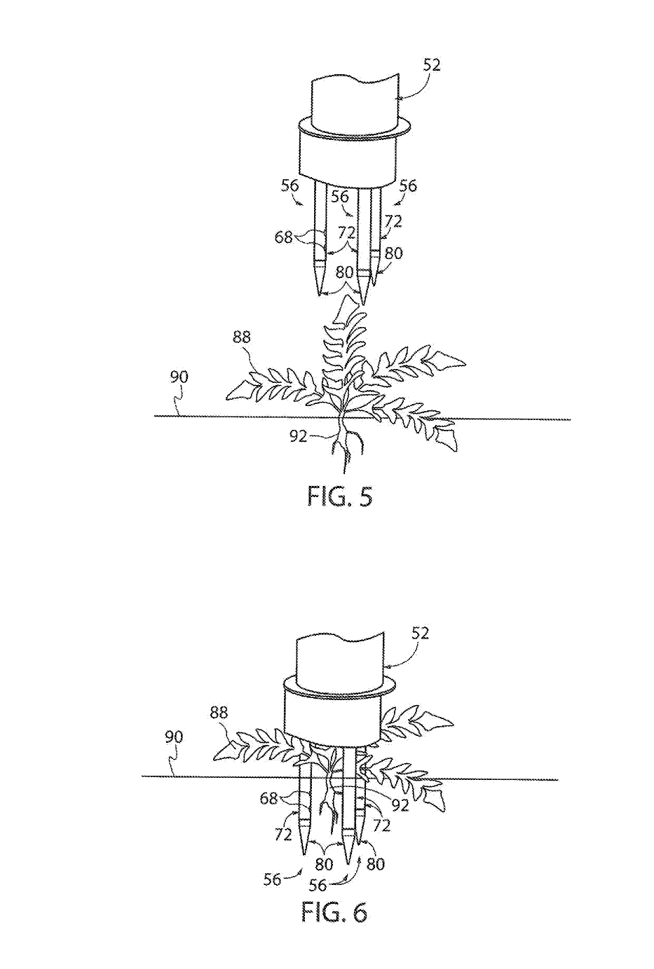

Referring to FIGS. 5 and 6, once the steam apparatus 10 is pressurized enough to eject steam, the user inserts the spikes 56 of the spike attachment 50 through the top soil 90 and into the ground surrounding the weed 88. The removable tips 80 and point 84 assist to penetrate the soil 90.

The spikes 56 may be positioned to surround a center of the weed 88. Once the full length of the spikes 56 are fully inserted into the soil 90, the user may press the trigger 30 of the steam gun 26 to expel steam from the steam apparatus 10. The steam travels out the nozzle 28, through the extension tube attachment 40, through the spike attachment 50, and exits through the ventilation holes 68 of the spikes 56 to be delivered directly to the roots 92 of the weed 88 underground. The holes 68 are oriented to expel the steam toward the center of the weed's roots 92. The different vertical positions of the holes 68 also allow the steam to penetrate different depths of the weed's roots 92.

The user may choose to lift the spikes 56 vertically during steam ejection to change the location of steam delivery, while still making sure that the ventilation holes 68 remain within the soil 90. After applying the trigger 30 for several seconds, for example five to six seconds, the user releases the trigger 30 and removes the spikes 56 form the soil 90. The user may then apply the spikes 56 to another weed 88 as needed. The user may be assisted by handle 34 when moving the housing 12 to a different location.

After application of the spikes 56 into the ground, moisture from the steam may mix with the soil 90, causing the ventilation holes 68 to get clogged with soil 90 or debris. The user may easily remove the blockage by unscrewing the removable tips 80 from the elongated tubes 72 of the spikes 56. The user may be facilitated by the depression 76 whereby the user places his or her finger within the depression 76 to provide a better grip on the removable tip 80. The user may twist the removable tip 80 to unscrew the removable tip 80 from the elongated tubes 72. The user may then clean or unclog the inside of the elongated tubes 72, removing any soil or debris that may have clogged the passageway through the elongated tubes 72 or the ventilation holes 68 from clear passage. Once the passageway has been cleared, the user can re-screw the removable tip 80 to the elongated tubes 72 by twisting the removable tip 80 with respect to the cylindrical body 82, to re-secure the removable tip 80 to the elongated tubes 72.

It is understood that the removeably tips 80 may be removed during storage or shipping as desired to provide a more compact storage.

It may also be desired to replace the removable tip 80 over time due to normal wear and tear or if a tip 80 breaks.

While the embodiment shown provides a spike attachment 50 having three parallel spikes, it is understood that the spike attachment 50 may take a different configuration without departing from the spirit of the invention. For example, the spikes 56 may be any number and any arrangement. Moreover, the length, size and shape of the spikes 56 may differ while still providing a removable tip 80 consistent with the spirit of the invention.

Certain terminology is used herein for purposes of reference only, and thus is not intended to be limiting. For example, terms such as “upper”, “lower”, “above”, and “below” refer to directions in the drawings to which reference is made. Terms such as “front”. “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

We claim:

1. A steam weed killing apparatus comprising:
a steam generator including a fluid chamber and a steam generating means;
a conduit providing a passageway for steam to pass from the steam generator to an outlet;
an attachment connectable to the conduit outlet and including
a manifold receiving steam from the outlet,
at least one spike attached to the manifold having an elongated hollow tube terminating at a removable tip body wherein the elongated hollow tube has at least one hole along a length of the elongated hollow tube.

2. The steam weed killing apparatus of claim 1 wherein the elongated hollow tube has two holes along the length of the elongated hollow tube.

3. The steam weed killing apparatus of claim 2 wherein the two holes are spaced apart along a length of the elongated hollow tube.

4. The steam weed killing apparatus of claim 1 wherein the attachment has at least two spikes

5. The steam weed killing apparatus of claim 4 wherein the attachment has three spikes attached to the manifold.

6. The steam weed killing apparatus of claim 4 wherein the at least one hole is oriented toward a middle point between the at least two spikes.

7. The steam weed killing apparatus of claim 1 wherein a rear end of the tip body has a threaded attachment to receive a second threaded attachment of the elongated hollow tube.

8. The steam weed killing apparatus of claim 1 wherein the tip body is stainless steel.

9. The steam weed killing apparatus of claim 1 wherein the tip body has a depression to facilitate rotation of the tip body with respect to the elongated hollow tube.

10. A steam weed killing apparatus attachment comprising:
an attachment connectable at a first end to a steam source and including
a manifold being at least partially hollow and connectable to the steam source at a first end,
at least one spike extending outward from a second end of the manifold and defined by an elongated hollow tube terminating at a tip wherein the elongated hollow tube has at least one hole disposed along a length of the elongated hollow tube and the tip body is removable.

11. The steam weed killing apparatus of claim 10 wherein the at least one spike is fixedly retained to the manifold.

12. The steam weed killing apparatus of claim 10 wherein there are three spikes arranged in a triangular formation.

13. The steam weed killing apparatus of claim 12 wherein the three spikes protrude from the manifold at different lengths.

14. The steam weed killing apparatus of claim 12 wherein the three spikes protrude from the manifold at substantially similar lengths.

15. The steam weed killing apparatus of claim 10 wherein the elongated hollow tube has two holes along the length of the elongated hollow tube.

16. The steam weed killing apparatus of claim 15 wherein the two holes are disposed at different locations along the at least one spike.

17. The steam weed killing apparatus of claim 10 wherein the tip forms a blunted end.

18. A method of killing weeds comprising the steps of:
providing a steam weed killing apparatus having
a steam generator;
an attachment connectable to the steam generator and including
a manifold receiving steam from the steam generator,
at least one spike attached to the manifold having an elongated hollow tube terminating at a removable tip body wherein the elongated hollow tube has at least one hole along a length of the elongated hollow tube;
connecting the attachment to the steam generator;
delivering steam through the attachment; and
rotating the tip body to remove the tip body from the elongated tube.

19. The method of claim 18 wherein the at least one spike is inserted into the ground to encircle a center of the weed.

20. The method of claim 18 further comprising the step of rotating the tip body to replace the tip body onto the elongated tube.
